(19) United States
(12) Patent Application Publication
(10) Pub. No.: US 2005/0034309 A1
(43) Pub. Date: Feb. 17, 2005

(54) Utility knife with compression wheel

(76) Inventors: Richard Arent, Menasha, WI (US); Dennis L. Wordell, Hortonville, WI (US)

Correspondence Address: Michael G. Cameron;Jackson Walker LLP, Suite 600, 2435 North Central Expressway, Richardson, TX, 75080, US

(21) Appl. No.: 10/897,299

(22) Filed: Jul. 22, 2004

Related U.S. Application Data
(63) Continuation-in-part of application No. 10/336,908, filed on Jan. 6, 2003.
(60) Provisional application No. 60/346,703, filed on Jan. 7, 2002.

(51) Int. Cl. B26B 11/00

(52) U.S. Cl. 30/123

(57) ABSTRACT

A tool for cutting compressible material, such as fiberglass insulation, comprised of a handle, a pivotable blade carrier housing, a blade carrier, with or without a razor blade slidable within the blade carrier and a compression wheel means is disclosed. A slidable locking mechanism slidably coupling the razor blade within the blade carrier allows the razor blade to be retracted into the tool. Pulling the tool along the surface of insulation material while applying downward pressure to the handle and hence compression wheel allows the rotating wheel to compresses the compressible material allowing a razor blade to make a straight cut through the entire thickness of the compressible material.

### CROSS REFERENCE TO RELATED APPLICATION; CLAIM OF PRIORITY

This application is a continuation-in-part of U.S. patent application Ser. No. 10/336,908, Arent, et al., filed Jan. 6, 2003, which claims priority to U.S. Provisional Patent Application No. 60/346,703, filed on Jan. 7, 2002, entitled “Utility Knife with Compression Wheel”, the entire contents of which are incorporated herein by this reference. The Applicant hereby claim the benefits of this earlier pending regular and provisional application under 35 U.S.C. Section 119(e).

### FIELD OF THE INVENTION

This invention relates to an improved cutting device adapted to cut fibrous compressible material, such as fiberglass insulation and other deep porous fabrics. Conventional devices are either ill-suited for cutting this type of material or are difficult and awkward to utilize.

### BACKGROUND OF THE INVENTION

Conventional utility knives, as seen in U.S. Pat. No. 4,524,518 to West (“West”), and U.S. Pat. No. 5,301,428 to Wilcox (“Wilcox”), are typically used to cut insulation and other compressible and non-compressible materials. Disadvantageously, several passes of the knife are usually required for a complete cut due to the thickness, low density and composition of these materials. In order to overcome this disadvantage, a user will sometimes place a straight edged flat object such as a board along the cut line to help compress the material prior to cutting. This method of cutting material is both awkward and difficult.

Adaptations of traditional utility knife designs such as those seen in U.S. Pat. No. 6,122,831 to Beckers et al., (“Beckers”), U.S. Pat. No. 5,075,974 to McIlhatten (“McIlhatten I”), U.S. Pat. No. 4,974,320 to Pelletier (“Pelletier”), U.S. Pat. No. 5,214,852 to Napolitano (“Napolitano”), U.S. Pat. No. 5,325,594 to Szafranski (“Szafranski”), and U.S. Pat. No. 5,943,780 to McIlhatten (“McIlhatten II”), have each attempted to overcome the cited disadvantage as well as other shortcomings of conventional utility knives. However, each invention has its own disadvantages.

For example, in West, a utility knife comprising a pair of complementary opposing elongated body sections is disclosed. The body sections are pivotally connected at a midpoint section of the handle and blade retaining portions. The body sections interlock by a tongue/slot engagement. A releasable locking means in the handle portion employs a button slidable in transverse openings. Notwithstanding its cited advantages, this utility knife does not have a compression wheel adapted to compress the material to be cut, nor does the blade carrier pivot away from the handle for ease of blade insertion or replacement.

Similarly, in Wilcox, a releasably locking handle for a retractable blade utility knife is disclosed. In Wilcox, the handle is formed from a pair of elongated mating handle halves connected by a central pivot. A slidable blade carrier is supported between the handle halves. The handle has a dual locking mechanism which provides for a pivotal opening of the handle when the blade carrier is in a fully forward position. A magnet which is fixed in the handle slidably supports the blade carrier. This utility knife does not have a compression wheel adapted to compress the material to be cut, nor does the blade carrier pivot away from the handle for ease of blade insertion or replacement.

In Pelletier, a utility knife including a handle with a razor cutting blade end and a toothed cutting wheel, not a compression wheel, at the other end is disclosed. An alternate embodiment includes a necked handle with a toothed cutting wheel affixed to a retractable arm which thereby allows the toothed cutting wheel to be retracted within the handle. The cutting wheel means is adapted to score a material such as drywall, not to compress a compressible fibrous material such as insulation. The objective of the Pelletier invention is distinctly different from that of the present invention. Furthermore, the blade is not secured such that its carrier can be pivoted away from the handle for ease of blade insertion or replacement.

In Napolitano, a fiberglass insulation cutting tool is disclosed which includes a blade extending forwardly from the front portion of a one-piece housing having a handle grip for the user to grasp onto. The front portion of the tool is rounded at the bottom and is tapered inwardly from its sides, to compress the fiberglass insulation the blade as the tool is dragged rearwardly. This means of compressing insulation does not use a compression wheel and hence is less precise than the present invention, nor does the invention disclose a blade carrier adapted to pivot away from the handle for ease of blade insertion or replacement.

In Szafranski, a hand-operated tool for cutting fibrous compressible insulation batts, and similar fibrous compressible materials is disclosed. The tool includes an elongated cutter blade housing and a planar sheet of plexiglass bent into a “C”-shaped configuration. End portions of the “C”-shaped plexi-glass sheet fit over the ends of the cutter blade housing, so that the “C”-shaped sheet forms a presser element for the insulation batt, when placed on the top surface thereof. When the cutter blade is drawn through the batt material, the presser element compresses the material so that the cutter blade is enabled to penetrate the batt material. However, the invention of Szafranski does not utilize a rotatable compression wheel. Disadvantageously, the “C”-shaped configuration increases friction, and hence requires more effort in the cutting process. Furthermore, the probability of causing a tear in the insulation are increased.

In McIlhatten I, a unitary device that does not require a utility knife, only a blade, is disclosed. The device of McIlhatten I, does not utilize a compression wheel adapted to compress the material to be cut, nor does the invention disclose a blade carrier adapted to pivot away from the handle for ease of blade insertion or replacement.

In Beckers, a conventional saw for cutting fibrous insulation batts in a single motion with one hand is disclosed. The device of Beckers, does not utilize a compression wheel adapted to compress the material to be cut, nor does the invention disclose a blade carrier adapted to pivot away from the handle for ease of blade insertion or replacement.

In McIlhatten II, a cutting tool for cutting a sheet of compressible fibrous material is disclosed. Similar to the device of Szafranski, the cutting tool includes a blade which forms part of a cutting assembly which is mounted on a supporting base for movement between an upper position in which the blade is located above the material to be cut when the supporting base rests on the material which a lower position in which the cutting blade extends below the supporting base. The cutting assembly the upper position and moved to the lower position by downward pressure from the hand of the operator which also causes the supporting base to compress the fibrous material so that when the cutting tool is moved longitudinally along the upper surface of the fibrous material, the material is cut by the blade. Similar to Szafranski, however, the invention of McIlhatten II does not utilize a rotatable compression wheel, thus resulting in increased friction between the cutter and the material. As a result, more effort is required in the cutting process and the probability of tearing the insulation are increased.

The present invention is an improvement over conventional and the disclosed utility knives in that it incorporates, among other things, a compression wheel located proximate the blade end of the handle which delivers several advantages over the conventional art as described herein as well as a blade carrier adapted to pivot away from the handle for ease of blade insertion or replacement.

### SUMMARY OF THE INVENTION

The present invention comprises a utility knife with an integrated compression wheel located proximate the blade end of the handle. The compression wheel is adapted to compress the material to be cut prior to coming in contact with the cutting blade, resulting in a cleaner cut. On the end opposite the blade end, a fixed or pivotably adjustable stuffblade is provided to assist in inserting insulation in confined spaces. A blade carrier is secured in a housing member which, in one embodiment, is pivotably mounted to the handle. The housing member can be released at one end thereof so as to permit said end to pivot away from the handle, facilitating the insertion or removal of a razor blade, such as a snap off blade, in the blade carrier.

### FIGURES OF THE INVENTION

FIG. 1 is a top, exploded view of the utility knife of the present invention with a first side in the foreground;

FIG. 2 is a bottom, exploded view of the utility knife of the present invention with the first side in the foreground;

FIG. 3 is a view of the first side of the utility knife of the present invention;

FIG. 4 is a view of a second side of the utility knife of the present invention;

FIG. 5 is a view of the front end of the utility knife of the present invention;

FIG. 6 is a view of the back end of the utility knife of the present invention;

FIG. 7 is a view of the top side of the utility knife of the present invention;

FIG. 8 is a view of the bottom side of the utility knife of the present invention; and

FIG. 9 is a side view of the present invention illustrating the ability of the pivotable blade carrier housing to pivot away from the handle to facilitate razor blade insertion and removal.

### DETAILED DESCRIPTION OF THE INVENTION

The present invention is an improved utility knife comprised of a handle, a fixed or pivotable blade carrier housing having slot openings at the ends thereof, a blade carrier and sled for extending and retracting a razor blade, such as a snap-off blade, a compression wheel means and, in one embodiment, a fixed or pivotable stuff blade at the end of the handle opposite the slot opening. The blade carrier is mounted within a pivotable blade carrier housing which is pivotably mounted to the handle so as to permit one end of the pivotable blade carrier housing to pivot away from the handle, so as to facilitate blade insertion and removal.

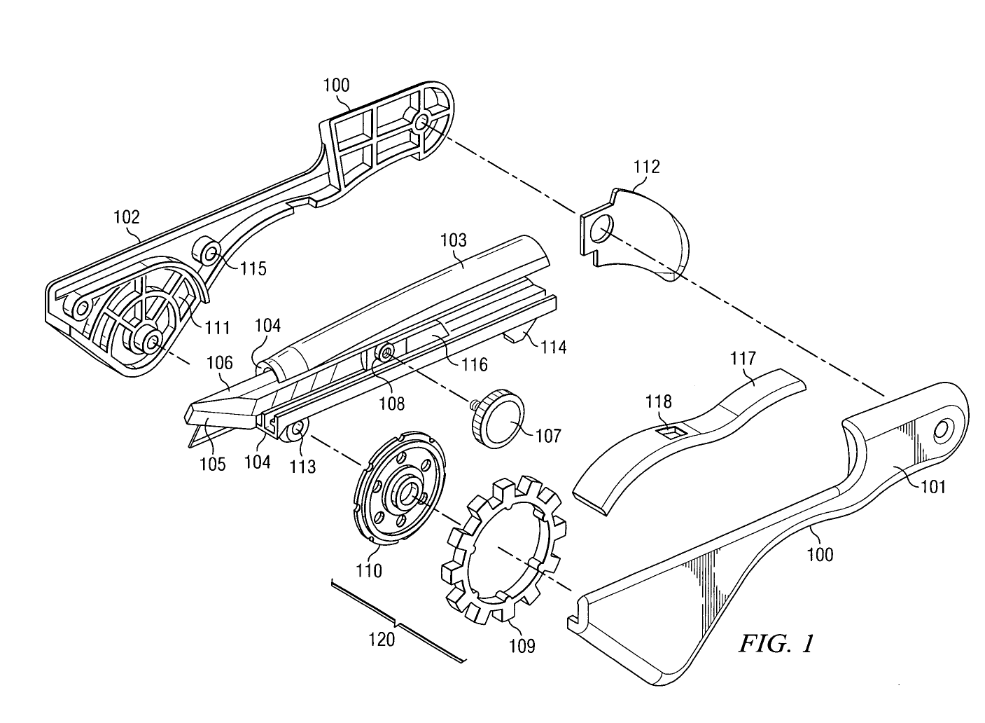

Referring to FIG. 1, a top, exploded view of an embodiment of the utility knife of the present invention with a first side in the foreground is presented. As seen in FIG. 1, the handle has a first elongated member 101 and a second elongated member 102 which are detachably secured and mated along a longitudinal plane. A spacer member 117 is secured between the underside portions of elongated members 101, 102. The underside of elongated members 101, 102 have a curved form adapted to provide a secure fit between the handle and the hand of the user.

A razor blade 105, such as a snap-off blade, is received into blade carrier 106. Razor blade 105 is thus able to slide in and out of blade carrier 106. Blade carrier 106 is held in place between first elongated member 101 and second elongated member 102 by pivotable blade carrier housing 103. Blade carrier 106 is located substantially within pivotable blade carrier housing 103, with a portion thereof extending through slot opening 104 of pivotable blade carrier housing 103. In this configuration, an end of razor blade 105 is operable to move toward and away from slot opening 104 and blade carrier 106. Pivotable blade carrier housing 103 is pivotably coupled at the first end of handle 100 at a pivot point located on the bottom, first end of pivotable blade carrier housing 103. The pivot point comprises shaft 115 which is inserted into round transverse aperture 113. At the bottom, second end of pivotable blade carrier housing 103, latch 114 is molded integral thereto

As noted, razor blade 105 slidably extends from blade carrier 106 for movement thereof. The slidable locking mechanism comprises male threaded knobbed bolt 107, and a female threaded shaft within sled 116. Sled 116 is insertable into the interior walls of blade carrier 106, with sled 116 being coupled to razor blade 105 and adapted to slide along the inner walls of blade carrier 106. The coupling of razor blade 105 to sled 116 permits razor blade 105 to be locked into one of a plurality of positions, with one end thereof being located outside of blade carrier 106.

A compression wheel means 120 is rotatably coupled to handle 100 proximate slot opening 104 of pivotable blade carrier housing 103. Compression wheel means 120 can be any smooth or teethed, substantially circular wheel, made of a material such as hardened rubber, plastic, steel or metal, which can compress compressible material. FIG. 1 illustrates compression wheel means 120 having an outer toothed gear 109 along the circumference of compression wheel 110 and being rotatably coupled to handle 100. Toothed gear 109 and compression wheel 110 can be combined in a single integral unit. The three dimensional relation of the compression wheel means 120 to handle 100 and razor blade 105 is such that if razor blade 105 is substantially in the y-z plane, then the axle through the center of the compression wheel means 120 is parallel to the x-axis perpendicular to the longitudinal y-axis of the handle 100. A partition 111 on each interior side of the first elongated member 101 and second elongated member 102 isolate the compression wheel means 120 inside handle 100.

Attached to the end of the handle 100 opposite the razor blade end is stuff blade 112. Stuff blade 112, used to force insulation or other material into confined spaces, can be fixed into a stationary position or made to pivot into and out of handle 100.

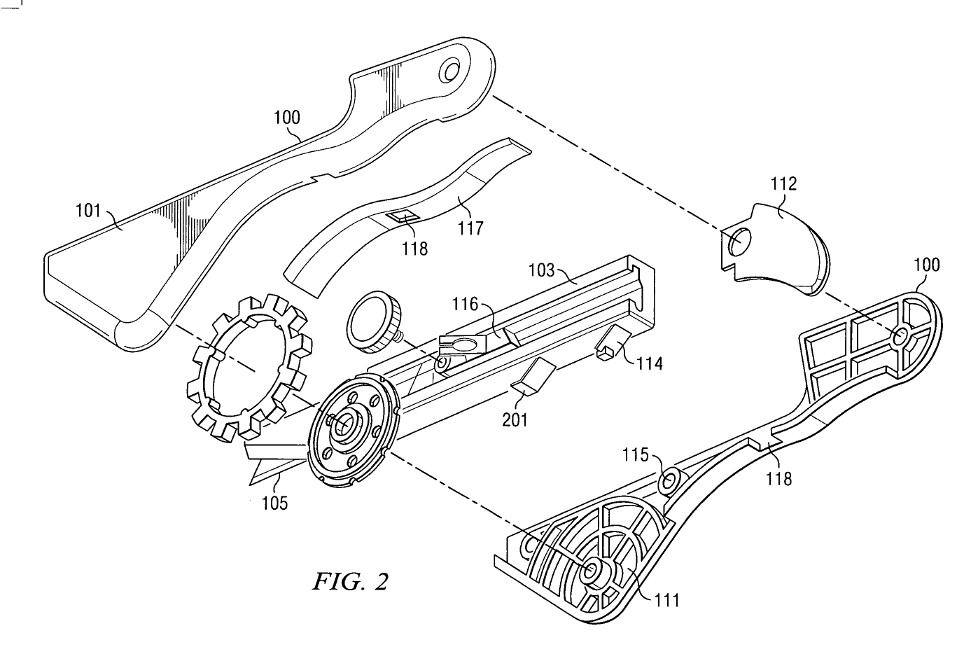

FIG. 2 is a bottom, exploded view of an embodiment of the utility knife of the present invention with the first side of handle 100 in the foreground. From this perspective, improved views of sled 116 of the slidable locking mechanism, stuff blade 112, partition 111, latch 114, and cutout 118 are seen. Tension member 201 is adapted to provide tension to pivotable blade carrier housing 103 against housing 100.

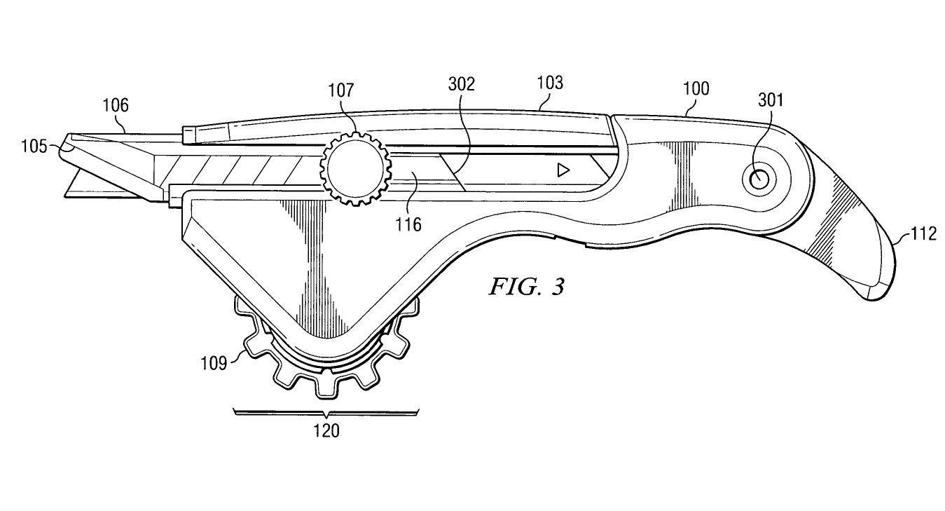

FIG. 3 is a view the first side of an embodiment of the utility knife of the present invention. As seen therein, the form factor of handle 100 serves to conceal approximately ⅓ of the compression wheel means 120 in partition 111 (as seen in FIGS. 1 and 2). This is but one of any number of configurations that can be utilized to rotatably hold the compression wheel means 120 in place. First side 302 of blade carrier 106 has a cutout along its longitudinal side, so as to permit locking mechanism sled 116 (as seen in FIGS. 1 and 2) to slide from a rear position to a forward position. Male threaded knobbed bolt 107 is coupled to sled 116 and can be loosened so as to allow sled 116 to slide along the inner walls of blade carrier 106 and hence permit the extension and retraction of razor blade 105 from blade carrier 106. Stuff blade 112 is seen fixably secured to the end of handle 100 opposite the blade end, but can be pivotably attached at pivot point 301 so as to permit stuff blade 112 to be utilized from a plurality of positions.

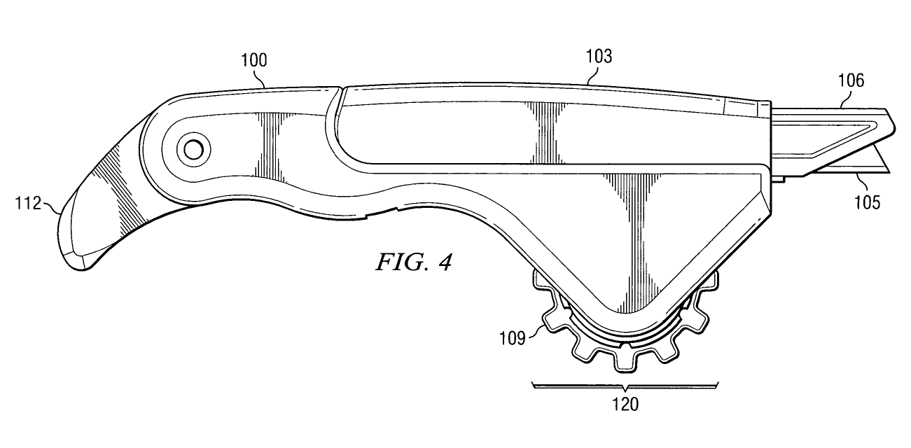

FIG. 4 is a second side of an embodiment of the utility knife of the present invention. As seen therein, the second side of pivotable blade carrier housing 103 is closed. The end of blade carrier 106 that extends from pivotable blade carrier housing 103 is angled from about 20 degrees to 50 degrees to expose only a portion of razor blade 105 while adding support to the sides of razor blade 105.

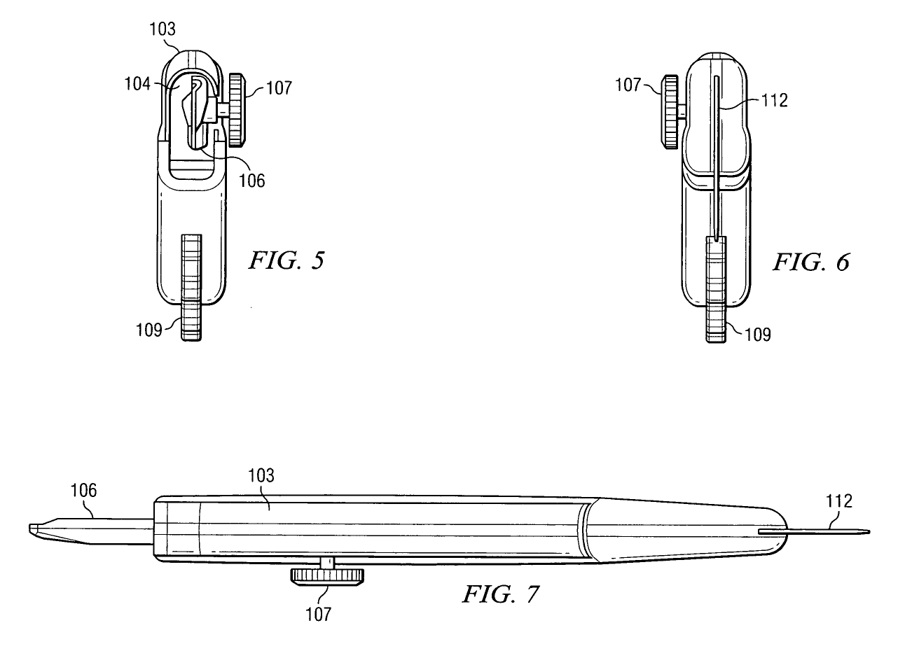

FIG. 5 is a front end view of an embodiment of the utility knife of the present invention. As seen therein, pivotable blade carrier housing 103 is dimensioned so as to form slot 104 at the first end thereof in which blade carrier 106 is insertable.

FIG. 6 is a back end view of an embodiment of the utility knife of the present invention showing the relative positions of fixed stuffblade 112, knobbed bolt 107 and toothed gear 109 of the compression wheel means 120.

FIG. 7 discloses the top side of an embodiment of the utility knife of the present invention has pivotable blade carrier housing 103, blade carrier 106, stuff blade 112, and knobbed bolt 107.

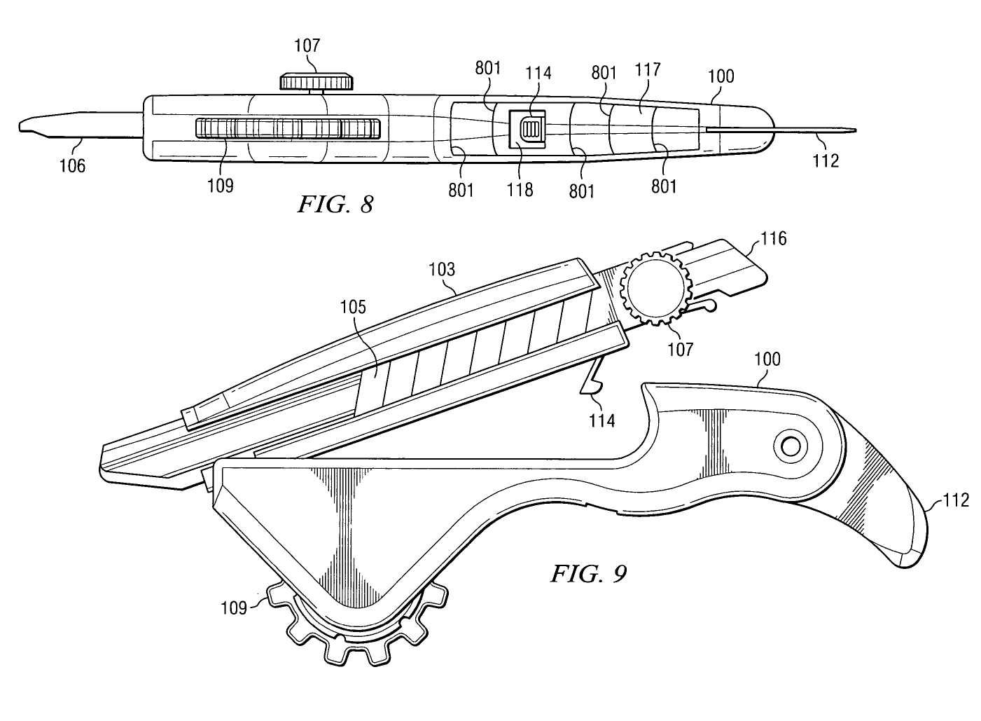

Referring to FIG. 8, the bottom side of an embodiment of the utility knife of the present invention is shown illustrating the relative positions of stuff blade 112, knobbed bolt 107, toothed gear 109 of the compression wheel means 120, latch 114 which snaps into cutout 118 of spacer member 117. Ribs 801 can be molded integral to spacer member 117 so as to increase the frictional co-efficient between the utility knife and the user.

As noted, latch 114 is received and snapped into cutout 118 to hold pivotable blade carrier housing 103 in place relative to handle 100. Referring to FIG. 9, when latch 114 is released, the second end of pivotable blade carrier housing 103 can be rotated away from handle 100. This permits sled 116 and razor blade 105 to be pulled out of blade carrier 103. This facilitates the efficient insertion of replacement of razor blades.

The handle, pivotable blade carrier housing, blade carrier, stuff blade and compression wheel components of the present invention can be made out of a variety of materials depending on the requirements of the user. These include, but are not limited to hardened rubber, resilient plastic, metal, aluminum or steel components. The hand grip member may be made of any material that is comfortable, yet assists the user in securing the utility knife. Such materials include resilient rubber, plastic and the like.

The advantageous position of the compression wheel means proximate the blade end of the handle provides added leverage in front of the grip portion of the handle to increase the amount of pressure which is exerted on the insulation. The utility knife of the present invention is thus operable to compresses and cut fibrous material such as fiberglass insulation in one continuous motion. In other words, a single motion compresses and cuts.

In operation, the user grasps the handle behind the compression wheel wrapping the fingers around the utility knife and the hand grip member. The user places the blade and compression wheel evenly on the surface to be cut and applies downward pressure. The user pulls the utility knife back along the cutting line, allowing the compression wheel to compress the cutting material prior to contact with the blade.

The utility knife with compression wheel and pivotable blade carrier housing for holding the blade carrier offers several advantages over conventional utility knives. For example, the user is assured an easier cut as less pressure will be required to cut compressed material. With less play in the cutting material there is a decrease in cutting variance as the gripping teeth help keep the cut straight. As a result, the user will have less waste due to cutting errors.

The innovative teachings of the present invention are described with particular reference to a utility knife with a compression wheel means and pivotable blade carrier housing for holding the blade carrier. The utility knife of the present invention is not limited to cutting compressible material. Furthermore, the present invention can be made with or without a stuff blade opposite the blade portion of the invention can be understood and appreciated by those skilled in the art that the arrangements, uses, and embodiments described herein provide only a few examples of the many advantageous uses and innovative teachings herein. Various alterations, modifications and substitutions can be made to the cutting device of the disclosed invention without departing in any way from the spirit and scope of the invention.

1. A cutting device, comprising:
a handle and a first and second opposite ends;
a blade carrier mounted substantially within the handle along the longitudinal axis thereof, the blade carrier having an exposed extension proximate the first end of the handle; and
a rotatable compression wheel located proximate the first end on the underside of the handle, said compression wheel extending partially outside the handle.

2. The device of claim 1, further comprising the blade carrier being adapted to slidably retract a razor blade into the first end of the handle.

3. The device of claim 1, further comprising the blade carrier being secured to a pivotable blade carrier housing in the handle, one end of the pivotable blade carrier housing being adapted to pivot away from the handle to permit the insertion and remove of razor blades in the blade carrier.

4. The device of claim 1, further comprising:
a locking sled mechanism;
the locking sled mechanism being slidably coupled to the blade carrier;
the locking sled mechanism being adapted to securely hold a razor blade; and
the locking sled mechanism being adapted to being slidably retract and extend a razor blade into and out of the blade carrier.

5. The device of claim 4, further comprising the locking sled mechanism being adapted to lock a razor blade into one of a plurality of locking positions.

6. The device of claim 5, further comprising the blade carrier having dimensioned therein a slot for receiving a blade.

7. The device of claim 6, in combination with a razor blade.

8. The device of claim 1, further comprising the compression wheel being made of a material from the groups of rubber, plastic or metal.

9. The device of claim 1, further comprising the compression wheel having geared teeth or being smooth along the outer circumference thereof.

10. The device of claim 1, further comprising a fixed stuff blade located on the second end of the handle.

11. The device of claim 1, further comprising a pivotably adjustable stuff blade located on the second end of the handle.

12. The device of claim 1, wherein the handle has a gripping means on the outside, underneath portion thereof, from just behind the compression wheel means to the second end of the handle.

13. The device of claim 1, in combination with a razor blade.

14. An improved utility knife, comprising:
an elongated handle with first and second opposite ends;
a pivotable blade carrier housing with first and second opposite ends, pivotably coupled to the upper portion of the elongated handle,
the second end of the pivotable blade carrier housing adapted to pivot away from the second end of the elongated handle;
a blade carrier securely mounted within the pivotable blade carrier housing;
a slidable, locking mechanism within the blade carrier adapted to receive and securely support a razor blade; and
the slidable, locking mechanism adapted to allow movement of a razor blade along the inner walls of the blade carrier.

15. The knife of claim 14, further comprising:
the blade carrier partially extending from said pivotable blade carrier housing; and
the slidable locking mechanism adapted to provide a plurality of locking positions for slidably adjusting the razor blade within the blade carrier.

16. The knife of claim 14, further comprising a compression wheel rotatably coupled proximate the underside of the first end of said elongated handle.

17. The improved utility knife of claim 16, further comprising the compression wheel having either a smooth surface or a toothed gearing along the outer circumference thereof.

18. The improved utility knife of claim 14, further comprising the handle having a stuff blade on the second end of the handle.

19. The improved utility knife of claim 14, in combination with a razor blade.

20. An improved utility knife, comprising:
a handle having first and second opposite ends;
a blade carrier with a first and second opposite ends for slidably receiving a razor blade located substantially within the handle along the longitudinal axis thereof, with the first end being open and extending outside the handle for exposing a razor blade;
a slidable locking mechanism slidably coupling a razor blade to the blade carrier, when locked, adapted to secure a razor blade to one of a plurality of locking positions along a longitudinal axis of the blade carrier; and
a compression wheel rotatably attached proximate the underside of the handle, the center of said wheel being located within the handle approximately ¼ of the distance from first end to the second end of the handle.

21. The knife of claim 20, further comprising a stuff blade being located at the second end of the handle.

22. A cutting device, comprising:
a handle and a first and second opposite ends;
a pivotable blade carrier housing pivotably coupled to the handle, one end of the pivotable support housing adapted to pivot away from the handle;
a blade carrier mounted substantially within the longitudinal axis of the pivotable blade carrier housing, the blade carrier having an exposed extension proximate the first end of the handle; and
a rotatable compression wheel located proximate the first end on the underside of the housing, said compression wheel extending partially outside the handle.
